(19) United States
(12) Patent Application Publication
(10) Pub. No.: US 2024/0067357 A1
(43) Pub. Date: Feb. 29, 2024

(54) Airborne Storage, Assembly and Launch Platform

(71) Applicant: Martin Daniel Holmes, Willcox, AZ (US)

(72) Inventor: Martin Daniel Holmes, Willcox, AZ (US)

(21) Appl. No.: 17/895,193

(22) Filed: Aug. 25, 2022

(51) Int. Cl. B64F 1/08; B64C 39/02; B64F 5/10

(52) U.S. Cl. CPC B64F 1/08; B64C 39/022; B64C 39/024; B64F 5/10; B64C 2201/08; B64C 2201/128; B64C 2201/20

(57) ABSTRACT

A system for airborne storage, assembly and launch of aircraft and spacecraft.

### CROSS-REFERENCE TO RELATED APPLICATIONS

This application claims benefit of U.S. Provisional App. Ser. No. 63/241,327, filed on Sep. 7, 2021.

### FIELD OF THE INVENTION

The present invention relates aerospace engineering devices and methods to storing, assembling, assisting, and launching aircraft and spacecraft from altitude.

### BACKGROUND OF THE INVENTION

The current methods for launching rockets are split into two main categories:
1) Ground launched rockets.
2) Vehicle-assisted rocket launches such as from an aircraft.

Ground launched rockets are highly inefficient, and require large, bulky, and expensive rocket stages to lift a payload into orbit and are often dependent on weather conditions. Ground launched rockets can only be launched from limited locations and depend on specific expensive equipment and preparation. Ground launched rockets experience heavy stresses and pressures that become even greater during the accelerations that are generated during a launch. These stresses and strains render rockets more susceptible to failure and demand meticulous maintenance and fairly extensive replacement of parts between every launch.

Vehicle-assisted rocket launches are complex, expensive and can also be dependent on weather conditions.

Both ground and vehicle-launched rockets can produce large amounts of environmentally damaging fumes on take-off and during efforts to reach the lower atmosphere.

### BRIEF SUMMARY OF THE INVENTION

The present disclosure relates to an airborne storage, assembly, and launch platform system configured to remain aloft at altitude through the use of reaction engines. The launch platform includes equipment to collect and store water vapor from the atmosphere. The launch platform includes a solar array to provide electricity and electrolysis equipment to provide hydrogen from water to power reaction engines required to keep the platform aloft. The launch platform includes landing and delivery areas to receive payload from aircraft, storage areas and staff accommodations with additional areas to assemble aircraft and spacecraft. The launch platform includes a winch and long cable with a drone attachment to enable the lower end of the cable to locate and mechanically latch on to and winch aircraft and other items, which can supply the platform with equipment, staff, fuel and other items to sustain the platform and staff. An emergency parachute system is provided for use in the case of any system failure.

### BRIEF DESCRIPTION OF THE DRAWINGS

FIG. 1 illustrates an airborne storage, assembly, and launch platform employed at altitude wherein the launch platform 1 comprises reaction engines 2, solar array 3, an electrolysis plant 4, hydrogen storage 5, a winch 6, cable 7, and cable attached drone 8, a hollow tube 9 including atmospheric water harvesting equipment (not shown) such as sorption-based water collecting or other materials or devices that include, or that can be equipped to include a suitable or equivalent atmospheric water harvesting system to collect water for conversion to hydrogen and other needs and a suction pump 10, a resupply vehicle 11, resupply vehicle payload 12, staff accommodation 13, equipment and tool storage 14, assembly and landing areas 15 and a parachute system 16. The objects, features and advantages of the present invention will be more readily appreciated upon reference to the following disclosure when considered in conjunction with the accompanying drawings, wherein reference numerals are used to identify the components in the various views.

### DETAILED DESCRIPTION OF THE PREFERRED EMBODIMENTS

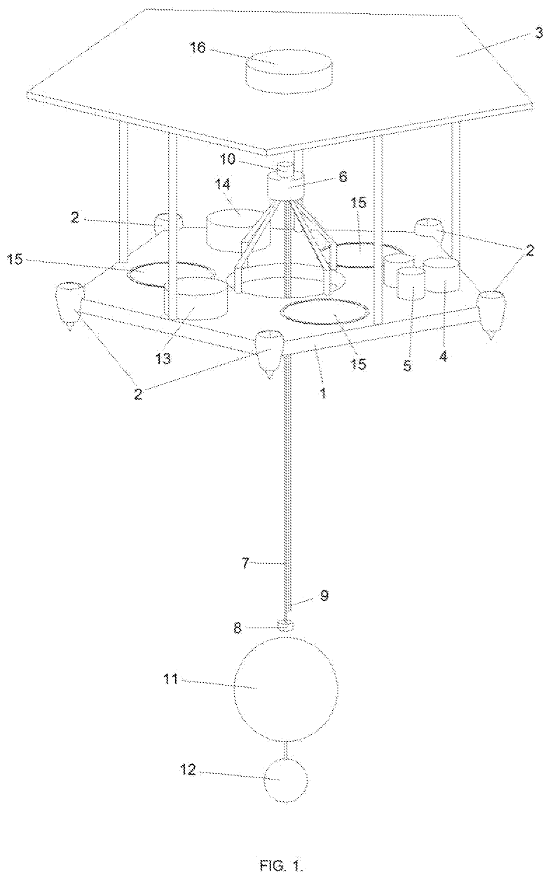

FIG. 1 illustrate an embodiment of an airborne storage, assembly and launch platform system according to the description and claims that follow. Aspects of the system may be embodied in an airborne storage, assembly and launch platform system shown airborne as illustrated in FIG. 1. The launch platform 1 will reach a desired altitude by utilizing its reaction engines 2 or another aircraft (not shown). Upon arrival at a desired altitude, the launch platform 1 will remain at a desired altitude and position by use of the reaction engines 2 and attached thrust vectoring nozzle mechanisms (not shown). The launch platform 1 includes components particular to an airborne storage, assembly and launch platform system 1. Common launch platform 1 components include reaction engines 2, staff accommodation 13, equipment and tool storage 14, assembly and landing areas 15 and a parachute system 16. Moreover, whereas the figures and written specification describe a particular system architecture, it is contemplated that a person of ordinary skill may modify the teachings herein to construct an airborne storage, assembly and launch platform system with an alternate system architecture. It follows that features described in preferred embodiments are not intended to limit the scope of the invention beyond what is expressly identified in the claims. Components that are particular to a launch platform 1 compatible with the airborne storage, assembly and launch platform system include a solar array 3, an electrolysis plant 4 and hydrogen storage 5, respectively to generate an electricity supply for an electrolysis plant 4 to convert water into hydrogen to fuel the reaction engines 2 and other power needs for the launch platform 1. Moreover, it should be apparent that any variety of reaction engine fuel may be implemented in the system. Components that are particular to a launch platform 1 compatible with the airborne storage, assembly and launch platform system include a hollow tube 9 including atmospheric water harvesting equipment (not shown) such as sorption-based water collecting or other materials or devices that include, or that can be equipped to include a suitable or equivalent atmospheric water harvesting system to collect water for conversion to hydrogen and other needs and a suction pump 10. Components that are particular to a launch platform 1 compatible with the airborne storage, assembly and launch platform system include a winch 6, cable 7, cable attached drone 8, a resupply vehicle 11 and resupply vehicle payload 12, respectively to locate, attach to aircraft, winch aircraft up, winch aircraft down for launch, winch other items to supply the platform with equipment, staff, fuel and necessities to sustain the platform and staff.

1. A system for airborne storage, assembly and launch of aircraft and spacecraft comprising:
a launch platform 1 and reaction engines 2 configured to retrieve, assemble, configure or launch aircraft and spacecraft.

2. The system of claim 1 wherein hydrogen to power the launch platform 1 and reaction engines 2 is provided by an electrolysis plant 4 and water.

3. The system of claim 1 wherein atmospheric water vapor is collected through a hollow tube 9 including atmospheric water harvesting equipment (not shown) such as sorption-based water collecting or other materials or devices that include, or that can be equipped to include a suitable or equivalent atmospheric water harvesting system to collect water for conversion to hydrogen and other needs and a suction pump 10.

4. The system of claim 1 wherein a winch 6 and cable 7 is used to launch aircraft from the launch platform 1.

5. The system of claim 1 wherein a winch 6, cable 7, cable attached drone 8 is used to locate, attach to aircraft, winch aircraft up and winch other items to supply the platform with equipment, staff, fuel and necessities to sustain the platform and staff.
